(19) United States
(12) Patent Application Publication
(10) Pub. No.: US 2024/0034823 A1
(43) Pub. Date: Feb. 1, 2024

(54) POLYMER PARTICLE PRODUCTION METHOD

(71) Applicant: Agency for Science, Technology and Research, Singapore (SG)

(72) Inventors: Srinivasa Reddy Mothe, Singapore (SG); Praveen Thoniyot, Singapore (SG)

(21) Appl. No.: 18/359,626

(22) Filed: Jul. 26, 2023

(30) Foreign Application Priority Data
Jul. 27, 2022 (SG) 10202250606EE

(51) Int. Cl. C08F 222/10; C08F 222/26; C08F 2/06

(52) U.S. Cl. CPC C08F 222/10; C08F 222/26; C08F 2/06

(57) ABSTRACT

A polymer particle production method includes: providing (12) one or more vinyl monomers; performing (14) free radical ring-opening polymerization (rROP) of cyclic ketene acetal (CKA) with the one or more vinyl monomers in a first organic solvent with a radical source to obtain a rROP reaction mixture; and emulsifying (16) the rROP reaction mixture in a second organic solvent to produce a plurality of polymer particles.

### CROSS-REFERENCES TO RELATED APPLICATIONS

This application claims benefit of priority under 35 U.S.C. § 119(a)—(d) to Singapore Patent Application No. 10202250606E, filed Jul. 27, 2022, and hereby incorporated herein by reference in its entirety.

### TECHNICAL FIELD

The present disclosure relates in general to polymer particles and more particularly to a polymer particle production method.

### BACKGROUND

Non-degradable microparticles in personal care industry are increasingly threatening to the biosphere due to their accumulation in the environment and are expected to pose long-term damaging effects, particularly for the oceans. Non-degradable microparticles may also enter food chains. The non-degradable polymers typically exist in the form of exfoliating microparticles or microbeads in many facial or body scrubs or decorative glitters in make-up products. This has led to the ban of microbeads in formulations affecting sensorial performance and efficacy of many formulations.

In such formulations, polyacrylate is one of the main components. Acrylate copolymers are commonly used in personal or consumer care applications due to their tunable functional properties that enable incorporation of required benefits in the formulations. A wide variety of acrylate-based polymers have been developed over the years with intended applications such as plastics, waterborne coatings, adhesives, nanocomposites, drug carriers, and scale control agents. As the usage of these synthetic polymers continually grows, the possible leakage of these polymers into the environment becomes unfortunately unavoidable. Therefore, it is necessary to develop degradable polyacrylates that do not persist for extended periods in the environment.

### SUMMARY

In a first aspect, the present disclosure provides a polymer particle production method. The polymer particle production method includes: providing one or more vinyl monomers; performing free radical ring-opening polymerization (rROP) of cyclic ketene acetal (CKA) with the one or more vinyl monomers in a first organic solvent with a radical source to obtain a rROP reaction mixture; and emulsifying the rROP reaction mixture in a second organic solvent to produce a plurality of polymer particles.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments will now be described, by way of example only, with reference to the accompanying drawings, in which:

FIG. 1 is a schematic flow diagram illustrating a polymer particle production method in accordance with an embodiment;

FIG. 2 is a schematic flow diagram illustrating a scheme for free radical ring-opening polymerization (rROP) of 2-methylene-1,3-dioxepane (MDO) with acrylate followed by Solvent Switch Technique to afford main-chain degradable polyacrylate microparticles;

FIG. 3A is a graph showing ¹H NMR (CDCl₃) analysis performed on microparticles of Sample 4a before hydrolytic degradation;

FIG. 3B is a graph showing ¹H NMR (CDCl₃) analysis performed on the microparticles of Sample 4a after hydrolytic degradation;

FIG. 3C is a graph showing ¹³C NMR (CDCl₃) analysis performed on the microparticles of Sample 4a before hydrolytic degradation;

FIG. 3D is a graph showing ¹³C NMR (CDCl₃) analysis performed on the microparticles of Sample 4a after hydrolytic degradation;

FIG. 4A is a graph showing gel permeation chromatography (GPC) analysis performed on the microparticles of Sample 4a before and after hydrolytic degradation;

FIG. 4B is a graph showing GPC analysis performed on microparticles of Samples 4b and 4c before hydrolytic degradation;

FIGS. 5A through 5D are optical microscopy images of the microparticles of Sample 4a at a scale bar of 10 μm;

FIGS. 6A and 6B are optical microscopy images of the microparticles of Sample 4b at a scale bar of 10 μm;

FIGS. 6C and 6D are optical microscopy images of the microparticles of Sample 4c at a scale bar of 10 μm;

FIG. 7A is a Scanning Electron Microscopy (SEM) image of the microparticles of Sample 4a at a scale bar of 10 μm;

FIG. 7B is an SEM image of the microparticles of Sample 4a at a scale bar of 100 μm;

FIGS. 7C through 7F are SEM images of the microparticles of Sample 4a at a scale bar of 1 μm;

FIG. 8A is an SEM image of the microparticles of Sample 4b at a scale bar of 10 μm;

FIG. 8B is an SEM image of the microparticles of Sample 4b at a scale bar of 100 μm;

FIG. 8C is an SEM image of the microparticles of Sample 4b at a scale bar of 10 μm;

FIG. 8D is an SEM image of the microparticles of Sample 4c at a scale bar of 100 μm;

FIGS. 8E and 8F are SEM images of the microparticles of Sample 4c at a scale bar of 10 μm;

FIG. 9A is a graph showing particle size distribution of the microparticles of Sample 4a as measured by a particle size analyzer, Mastersizer 3000 Hydro MV;

FIG. 9B is a graph showing particle size distribution of the microparticles of Sample 4b as measured by the particle size analyzer;

FIG. 9C is a graph showing particle size distribution of the microparticles of Sample 4c as measured by the particle size analyzer;

FIGS. 10A through 10E are graphs comparing various polymerization methods by ¹ H NMR (CDCl₃) analysis;

FIG. 11 are graphs illustrating cytotoxicity of (A) RAW macrophage cells, (B) HaCat keratinocyte cells and (C) NIH/3T3 fibroblast cells in media containing different concentrations of polymer and oligomers;

FIG. 12 is a schematic flow diagram illustrating a scheme for free radical ring-opening polymerization of (rROP) of MDO with styrene followed by Solvent Switch Technique to afford main-chain degradable polystyrene microcapsules;

FIG. 13 is a schematic flow diagram illustrating a Solvent Switch Technique process to make core-shell degradable polystyrene microcapsules;

FIGS. 14A, 14B and 14D are SEM images of degradable polystyrene microcapsules with hexadecane as core material at a scale bar 1 μm;

FIG. 14C is an SEM image of degradable polystyrene microcapsules with hexadecane as core material at a scale bar of 10 μm;

FIGS. 15A and 15C are SEM images of degradable polystyrene microcapsules with heptane as core material at a scale bar of 1 μm;

FIGS. 15B and 15D are SEM images of degradable polystyrene microcapsules with heptane as core material at a scale bar of 10 μm;

FIG. 16A is a graph showing particle size distribution of degradable polystyrene microcapsules with hexadecane as core material; and

FIG. 16B is a graph showing particle size distribution of degradable polystyrene microcapsules with heptane as core material.

### DETAILED DESCRIPTION

The detailed description set forth below in connection with the appended drawings is intended as a description of presently preferred embodiments, and is not intended to represent the only forms in which the present invention may be practiced. It is to be understood that the same or equivalent functions may be accomplished by different embodiments that are intended to be encompassed within the scope of the invention.

The term “polymer particle” as used herein refers to a particulate body of micro- or nano-dimensions made up of two or more monomer units.

The term “vinyl monomer” as used herein refers to a molecule having a C═C bond that can undergo polymerisation. Examples of vinyl monomers include, but are not limited to, acrylate monomer, vinyl acrylate monomer, methacrylate (MA) monomer, methyl methacrylate (MMA) monomer, ethylene glycol dimethylacrylate (EGDMA) monomer, 2-hydroxyethyl acrylate (HEA) monomer, n-butyl methacrylate (n-BuMA) monomer and styrene monomer.

The term “free radical ring-opening polymerization (rROP)” as used herein refers to a cyclic moiety undergoing polymerization initiation by a radical generated from an initiator. This initiation process leads to formation of a ring-closed radical, which exhibits greater ring-strain and steric effect. As a result of these structural features, the stable ring-opened radical that is subsequently produced and undergoes propagation during polymerization possesses.

The term “cyclic ketene acetal (CKA)” as used herein refers to an olefin that is substituted at one end by two hetero atoms connected together by a chain. An example of cyclic ketene acetal (CKA) includes, but is not limited to, 2-methylene-1,3-dioxepane (MDO).

The term “organic solvent” as used herein refers to a carbon-based compound that is used to dissolve another substance. Examples of organic solvents include, but are not limited to, acetonitrile (CH₃CN), ethanol (EtOH), tert-butanol (t-BuOH), isopropyl alcohol (IPA), dioxane, acetone, dimethylsulfoxide (DMSO), tetrahydrofuran (THF), methanol, propanol, hexadecane, heptane and dichloromethane (DCM).

The term “radical source” as used herein refers to a substance or agent that generates radicals when decomposed under certain conditions. These radicals are highly reactive species with unpaired electrons participating in chain reactions, leading to formation of new chemical bonds and growth of polymer chains. Examples of radical sources include, but are not limited to, azobisisobutyronitrile (AIBN) and di-tert-butyl peroxide (DTBP).

The term “about” as used herein refers to both numbers in a range of numerals and is also used to indicate that a value includes the standard deviation of error for the device or method being employed to determine the value. The term “about” as used herein can allow for a degree of variability in a value or range, for example, within 10%, within 5%, or within 1% of a stated value or of a stated limit of a range.

The term “stabilizer” as used herein refers to chemicals added to a substance that prevents degradation or maintains stability of a chemical compound or system from undesirable reactions or degradation caused by factors like heat, light, oxygen or any other environmental conditions and the term “non-ionic stabilizer” as used herein refers to a stabilising agent that lacks an ionic charge and is utilized to maintain stability and prevent degradation of the chemical compound or system without involving any ionic interactions. Examples of non-ionic stabilizers include, but are not limited to, polyvinylpyrrolidone (PVP) K-30 and poly(ethylene glycol)-block-poly(ϵ-caprolactone) (PEG-b-PCL). The term “stabilizer loading” as used herein refers to an amount or concentration of stabilizer that is added to a system or formulation to provide a desired level of stability.

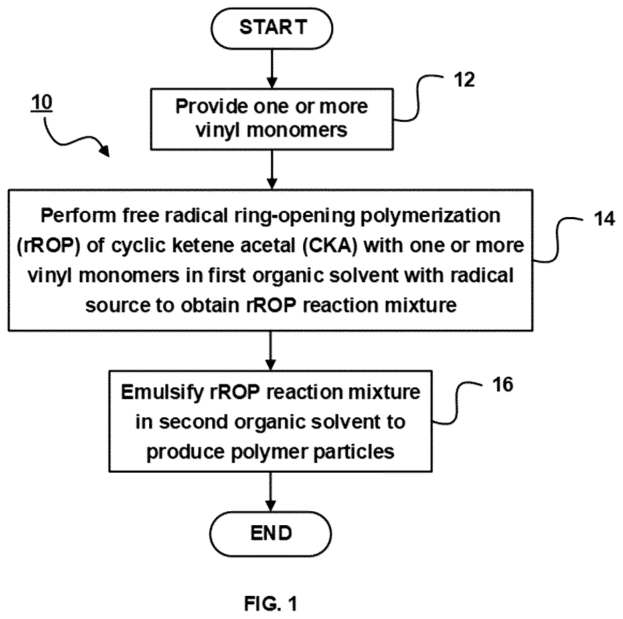

Referring now to FIG. 1, a polymer particle production method 10 is shown. The method 10 begins at step 12 by providing one or more vinyl monomers. The one or more vinyl monomers may be one or more selected from a group consisting of acrylate monomer, vinyl acrylate monomer, methacrylate (MA) monomer, methyl methacrylate (MMA) monomer, ethylene glycol dimethylacrylate (EGDMA) monomer, 2-hydroxyethyl acrylate (HEA) monomer, n-butyl methacrylate (n-BuMA) monomer and styrene monomer.

At step 14, free radical ring-opening polymerization (rROP) of cyclic ketene acetal (CKA) is performed with the one or more vinyl monomers in a first organic solvent with a radical source to obtain a rROP reaction mixture. The cyclic ketene acetal (CKA) may be 2-methylene-1,3-dioxepane (MDO).

A monomer ratio of the one or more vinyl monomers is to the cyclic ketene acetal (CKA) may be from between about 50:50 to about 80:20.

The first organic solvent may be selected from a group consisting of acetonitrile (CH₃CN), ethanol (EtOH), tert-butanol (t-BuOH), isopropyl alcohol (IPA), dioxane, acetone, dimethylsulfoxide (DMSO) and tetrahydrofuran (THF).

The radical source may be selected from a group consisting of azobisisobutyronitrile (AIBN) and di-tert-butyl peroxide (DTBP).

A non-ionic stabilizer may be added to a mixture of the cyclic ketene acetal (CKA), the one or more vinyl monomers and the radical source at step 14 before addition of the first organic solvent. The non-ionic stabilizer may be selected from a group consisting of polyvinylpyrrolidone (PVP) or poly(ethylene glycol)-block-poly(ϵ-caprolactone) (PEG-b-PCL). The rROP reaction mixture may have a stabilizer loading of between about 0.33 percentage by mass (wt %) and about 10 wt % of a total reaction mixture.

At step 16, the rROP reaction mixture is emulsified in a second organic solvent to produce a plurality of polymer particles. The rROP reaction mixture may be added dropwise into the second organic solvent at step 16. The second organic solvent may be one or more selected from a group consisting of methanol, ethanol, propanol, hexadecane, heptane and dichloromethane (DCM).

Advantageously, the polymer particles obtained from the polymer particle production method 10 are highly pure and stable as the organic-to-organic solvent combination eliminates short-chain polymers from the system. In addition, with periodical distribution of ester units throughout the polymer chain, degradable (aliphatic ester) units in the polymer backbone are optimal to result in oligomers with an average molecular weight of smaller than 600 Da to enhance environmental biodegradability of the polymer particles.

Further advantageously, the polymer particle production method 10 allows preparation of microparticles with narrow particle size and molecular weight distribution using conventional polymerization and emulsification conditions without requiring special equipment or a high shear homogenizer.

As proof of scalability, the polymer particle production method 10 was initially tested on a 1-gram scale and then a 10-gram scale without any synthetic or technical issues.

### EXAMPLES

### Experimental Results

All chemicals were purchased from Sigma Aldrich and used as received unless otherwise stated. 2-methylene-1,3-dioxepane (MDO) and PEG-b-PCL (poly(ethylene glycol)-b-polycaprolactone) were synthesized. Methyl methacrylate (MMA), methyl acrylate (MA), 2-hydroxyethyl acrylate (HEA) and ethylene glycol dimethylacrylate (EGDMA) were passed through basic Al₂O₃ before polymerization to remove inhibitors. To avoid difficulty in analysis, CDCl₃ was passed through anhydrous Na₂CO₃ to remove any traces of internally formed hydrochloric acid which may cause hydrolysis of polyester and unreacted MDO.

Spectra were recorded on a 400 MHz Bruker Ultrashield Avance 400SB Spectrometer equipped with a BPO probe and variable temperatures capabilities operating at a Larmor frequency of 400.23 MHz for ¹H and 100.65 MHz for ¹³C using chloroform-d (CDCl₃) as solvent and tetramethylsilane (TMS, δ=0) as internal reference at 21° C. One-dimensional ¹H NMR spectra was acquired with 64746 data points, 64 scans, 29.9585 ppm spectral width (11990.407 Hz), 1 second (s) delay, 2.70 s acquisition time and a 25° flip angle. One-dimensional ¹³C NMR spectra were recorded with 65536 data points, 4000 to 15700 scans, 238.2643 ppm spectral width (23980.814 Hz), 10 s relaxation delay, 1.37 s acquisition time and a 90° flip angle with inverse-gated decoupling.

Gel permeation chromatography (GPC) was conducted on a Viscotek TDAmax which consists of three components—the GPCmax integrated solvent and sample delivery module, the TDA 302 Triple Detector Array, and the OmniSEC software. The TDA 302 incorporates RI and Light Scattering detectors and viscometer. Only the RI detector was used. 2 columns: 2×PLgel 10 μm Mixed-B (500 to 10,000,000) were applied in sequence for separation. Tetrahydrofuran (THF) was used as the eluent at 1.0 mL/min with column and detector temperature at 40° C. Polystyrene standards were used for conventional calibration.

Optical microscopy measurement was conducted using Nikon Eclipse Ci transmitted brightfield and darkfield microscope. Scanning electron microscopy (SEM) measurement was conducted using JSM7900FLV. The particle dispersion was placed and dried on a silica substrate supported by carbon tape and examined at an acceleration voltage of 2 kV to 5 kV. Particle size distribution measurements of microparticles were performed with a Malvern Mastersizer 3000 Hydro MV (Malvern, United Kingdom) using refractive index of 1.33 and 1.49 for water and PMMA, respectively (refractive index for blue light set as 1.6).

A study was performed to investigate making degradable polyacrylate microparticles from free radical ring-opening polymerization (rROP) of 2-methylene-1,3-dioxepane (MDO) with methyl methacrylate (MMA) in a single step and the results are summarized in Table 1 below.

TABLE 1
Screening reaction conditions for synthesis and characterisation of poly(MDO-co-MMA) microparticles

| | | | | MDO | |
|---|---|---|---|---|---|
| | | | | Incorporation | |
| Experiment | MMA:MDO:EGDMA | Solvent | Conditions | (%)^{a} | Remarks |
| 1 | 40:50:10 | CH₃CN | AIBN (0.01 equiv), PVP | 20 | No particle |
| | | | K-30 (0.33 w/w %), | | formation |
| | | | 70° C., 24 h | | observed |
| 2 | 40:50:10 | EtOH | AIBN (0.01 equiv), PVP | —^{b} | No particle |
| | | | K-30 (0.33 w/w %), | | formation |
| | | | 70° C., 24 h | | observed |
| 3 | 40:50:10 | CH₃CN | AIBN (0.01 equiv), PEG- | 37 | No particle |
| | | | PCL (0.33 w/w %), | | formation |
| | | | 70° C., 24 h | | observed |
| 4 | 40:50:10 | EtOH | AIBN (0.01 equiv), PEG- | —^{c} | No particle |
| | | | PCL (0.33 w/w %), | | formation |
| | | | 70° C., 24 h | | observed |
| 5 | 50:50:0 | EtOH | AIBN (0.01 equiv), PVP | 2 | No particle |
| | | | K-30 (0.33 w/w %), | | formation |
| | | | 70° C., 24 h | | observed |
| 6 | 70:20:5:5 | CH₃CN | AIBN (0.01 equiv), PVP | —^{b} | Aggregation |
| | (HEA) | | K-30 (4 w/w %), | | of particles |
| | | | 70° C., 24 h | | observed |
| 7 | 70:20:5:5 | t-BuOH | AIBN (0.01 equiv), PVP | —^{b} | Flocculation |
| | (HEA) | | K-30 (4 w/w %), | | of particles |
| | | | 70° C., 24 h | | observed |
| 8 | 50:40:10 | IPA | AIBN (0.01 equiv), PVP | —^{b} | No particle |
| | | | K-30 (4 w/w %), | | formation |
| | | | 70° C., 24 h | | observed |
| 9 | 50:40:10 | MeOH | AIBN (0.01 equiv), PVP | —^{b} | Microparticle |
| | | | K-30 (4 w/w %), | | formation |
| | | | 70° C., 24 h | | observed |
| 10 | 60:35:5 | MeOH | AIBN (0.01 equiv), PVP | —^{b} | Microparticle |
| | | | K-30 (4 w/w %), | | formation |
| | | | 70° C., 24 h | | observed |

^{a}Determined by ¹H NMR analysis;
^{b}MDO incorporation was not found by ¹H NMR analysis;
^{C}20% of blocky-type MDO incorporation was observed by ¹H NMR analysis

The reactivity ratios of reacting monomers in a free radical polymerization play an important role to balance each monomer unit in the polymer backbone. The estimated reactivity ratios for the different acrylate and MDO systems was reported to be not a big difference (rAcrylate=1.76−3.35 and rMDO=0.04−0.16) so it was predicted that this favourable reactivity ratio could help in the study to control the mol % of degradable units in the polymer carbon-carbon backbone.

As can be seen from Experiments 1 and 3 summarised in Table 1 above, using MMA, MDO and ethylene glycol dimethylacrylate (EGDMA) in a ratio of 4:5:1 with azobisisobutyronitrile (AIBN) as a radical source, polyvinylpyrrolidone (PVP) K-30 or poly(ethylene glycol)-block-poly(ϵ-caprolactone) (PEG-b-PCL) as a stabilizer (0.33 wt % of total reaction mixture) in anhydrous acetonitrile at 70° C. for 24 hours under argon, plain poly(MDO-co-MMA) with 20% and 37% polymer backbone degradability, respectively, was produced.

As can also be seen from Experiments 2 and 4 summarised in Table 1 above, repeating the same conditions in ethanol produced polymer with neither random MDO incorporation nor particle formation.

According to Experiment 3 summarised in Table 1 above, absence of EGDMA did not produce any impact on the outcome of the results.

According to Experiments 6 and 7 summarised in Table 1 above, varying monomer ratios with the addition of 2-hydroxyethyl acrylate (HEA) as co-monomer and increasing stabilizer loading in acetonitrile or tent-butanol produced polymer with no incorporation of MDO. In these experiments, observed particle aggregation or flocculation could be the effect of HEA.

Experiments 9 and 10 summarised in Table 1 above demonstrated that non-degradable polyacrylate microparticles can be produced with the same monomer ratio of 4:5:1 or a slight modification (6:3.5:0.5 of MMA, MDO and EGDMA) by increasing loading of PVP K-30 to 4 wt % in methanol.

Experiment 8 summarised in Table 1 above demonstrated that changing methanol to isopropyl alcohol (IPA) under the same conditions as Experiments 9 and 10 had no influence on particle formation or MDO insertion.

By carefully analyzing the reaction conditions and outcomes of polymerization of Experiments 1 to 10 summarised in Table 1 above, it was discovered that a non-protic and protic solvent combination could afford degradable microparticles.

Reaction conditions were further studied by performing polymerization in acetonitrile with varying monomer ratios and stabilizer loading. This was followed by subsequent emulsification in methanol and the results are summarized in Table 2 below.

TABLE 2
Optimization of reactions conditions for synthesis and characterization of
poly(MDO-co-acrylate) microparticles (Samples 4a to 4c)

| | Vinyl | | | MDO | Particle size | |
|---|---|---|---|---|---|---|
| Sample | acrylate:MDO | Sol- | | Incorporation | distribution/ | |
| ID | (50:50) | vent | Conditions | (%)^{a} | PDI^{d} | |
| 4a^{b} | MMA:MDO | CH₃CN | 1. AIBN (0.01 equiv), | 17 | 4.7 | μm/0.008 |
| 4a^{c} | MMA:MDO | CH₃CN | PVP K-30 (1.65 w/w %), | 17 | 5 | μm/0.008 |
| 4b | MA:MDO | CH₃CN | 70° C., 24 h | 17 | 11.1 | μm/0.03 |
| 4c | nBuMA:MDO | CH₃CN | 2. MeOH, RT, 16 h | 30 | 10.4 | μm/0.4 |

^{a}Determined by ¹H NMR analysis;
^{b}Performed on a 1-gram scale of MDO;
^{c}Performed on a 10-gram scale of MDO;
^{d}Results obtained from Malvern Mastersizer 3000 Hydro MV (Malvern, United Kingdom)

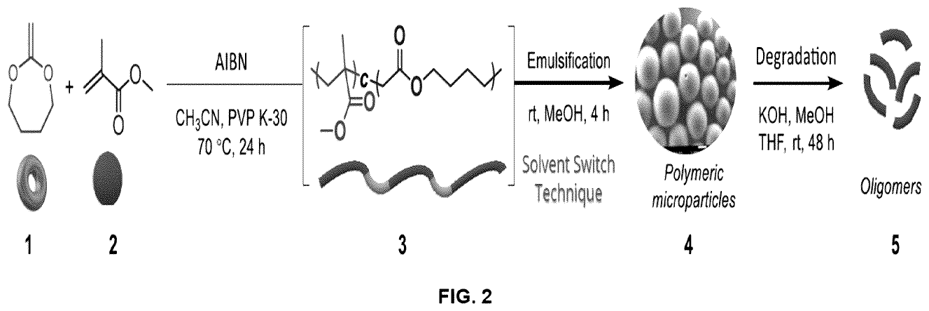

Referring now to FIG. 2, a scheme for free radical ring-opening polymerization (rROP) of 2-methylene-1,3-dioxepane (MDO) with acrylate followed by Solvent Switch Technique to afford main-chain degradable polyacrylate microparticles is shown.

For the rROP of MDO with MMA, a mixture of monomers MDO (89.89 mmol, 1.0 equiv) and MMA (89.89 mmol, 1.0 equiv) was transferred to 50 mL single-neck RBF (rinsed with Et₃N and vacuum dried before monomer transfer) containing AIBN (1.79 mmol, 0.01 equiv) and PVP K-30 (1.93 g, 10 wt % against total monomer weight) followed by addition of acetonitrile (100 mL, solid content: 20 wt %). The resulting homogeneous reaction mixture was degassed by argon for 1 hour at 0° C. to avoid evaporation of monomers and solvent. It was then was dipped in pre-heated silicon oil at 70° C. for 24 hours under an argon gas atmosphere. After this time, sampling was done to estimate the reaction conversion by ¹H NMR analysis. Later, the reaction was quenched by rapid cooling.

As part of the Solvent Switch Technique, the obtained reaction mixture was added dropwise to 500 mL of methanol under stirring with a magnetic stir bar at 700 rpm. The resultant dispersion was stirred at the same agitation speed for 4 hours.

After performing the Solvent Switch Technique, all polymeric emulsions were purified by gravity force standing reaction emulsion at room temperature for about 1 hour where microparticles settle out of the suspension. The remaining suspension containing smaller particles (<1 μm) was removed by decanting. This process was repeated 2 to 3 times by adding fresh methanol each time, ensuring all reagents used in the polymerization were eliminated successfully prior to NMR analysis.

To produce Sample 4a, polymerization was performed in acetonitrile with MDO:MMA in a ratio of 1:1, AIBN as a radical source, PVP K-30 as a stabilizer (1.65 wt % of total reaction mixture) in anhydrous acetonitrile, stirring at 70° C. for 24 hours under an argon atmosphere. This was followed by dropwise addition of the resultant reaction mixture into methanol (Solvent Switch Technique) at room temperature for 4 hours to produce degradable poly(methyl methacrylate) (PMMA) microspheres with 17% of cleavable ester units in the main chain of the polymer.

As can be seen from Sample 4b summarised in Table 2 above, very similar results were achieved when performing the reaction conditions of Sample 4a with methyl acrylate (MA).

In another experiment to produce Sample 4c as summarised in Table 2 above, the same conditions as used for Sample 4a were repeated with n-butyl methacrylate (n-BuMA) and this yielded poly(MDO-co-nBuMA) microparticles with surprisingly higher incorporation of MDO.

The progress of the reactions was monitored by ¹H NMR analysis. The yield and solid content for the particles of Samples 4a to 4c were calculated as 55-65% and 10 wt %, respectively.

NMR data for 4a: solid content 10 wt %; ¹H NMR (400 MHz, CDCl₃-d), δ (TMS, ppm): 3.95 (bs, 2 H (—C(O)O—CH₂*—CH₂—CH₂—CH₂—, MDO), 3.63-3.55 (m, 3H (—C(O)OCH₃*—, MMA), 2.73-2.62 (m, 2H, —CH₂*—C(O)O—, MDO), 2.35-2.19 (m, 2H, —CH₂*—C(O)O—, MDO), 1.94-1.72 (m, 2H (—CH₂*—, MMA), 1.59-1.38 (m, 2H (—C(O)O—CH₂—CH₂*—CH₂—CH₂—, MDO)+(m, 2H (—C(O)O—CH₂—CH₂—CH₂—CH₂—, MDO), 1.24-0.79 (m, 2H, (—C(O)O—CH₂—CH₂—CH₂—CH₂—, MDO)+(m, 3H, —CH₃, MMA); ¹³C NMR (400 MHz, CDCl₃-d), δ(TMS, ppm): 178.2-176.5 (—C*(O)O—CH₃, MMA), 171.3- 170.4 (—C*(O)O—, MDO), 64.4 (—C(O)O—C*H₂—, MDO), 54.4, 52.1, 51.8, 45.0, 44.5, 44.1, 43.7, 43.1, 28.4, 26.2, 23.5, 18.7, 17.9, 16.3.

NMR data for 4b: solid content 10 wt %; ¹H-NMR (400 MHz, CDCl₃-d), δ (TMS, ppm): 4.03 (bs, 2 H (—C(O)O—CH₂*—CH₂—CH₂—CH₂—, MDO), 3.71-3.39 (m, 3H (—C(O)O—CH₃—, MA), 2.81-2.61 (m, 2H, —CH₂*—C(O)O—, MDO), 2.50-2.32 (m, 2H, —CH₂—C(O)O—, MDO), 2.17-2.02 (m, 2H (—CH₂*—, MA), 1.83-1.26 (m, 6H (—C(O)O—CH₂—CH₂*—CH₂*—CH₂*—, MDO).

NMR data for 4c: solid content 10 wt %; ¹H NMR (400 MHz, CDCl₃-d), δ (TMS, ppm): 4.13-3.93 (m, 4 H (—C(O)O—CH₂*—CH₂—CH₂—CH₂—, MDO)+(m, 2H (—C(O)O—CH₂*—, nBuMA), 2.77-2.65 (m, 2H, —CH₂*—C(O)O—, MDO), 2.42-2.25 (m, 2H, —CH₂*—C(O)O—, MDO), 2.11-0.86 (m, 2H (—CH₂*—, nBuMA)+(m, 6H (—C(O)O—CH₂—CH₂*—CH₂*—CH₂*—, MDO)+(m, 7H, —C(O)O—CH₂—CH₂*—CH₂*—CH₂*—, nBuMA).

After performing the Solvent Switch Technique, all the polymeric emulsions were filtered through cotton to eliminate agglomerated particles. Subsequent to that, the emulsions were further purified by gravity force by standing the reaction emulsions at room temperature for about 1 hour to allow the microparticles to settle out of the suspensions. The smaller particles (<1 μm) remaining in the suspensions were removed by decanting. This process was repeated 2 to 3 times by adding fresh methanol each time to ensure all reagents used in the polymerization process were eliminated successfully prior to NMR analysis. This purification process led to the lowering of the solid content from an initial feeding of 20 wt % to a final 10 wt %.

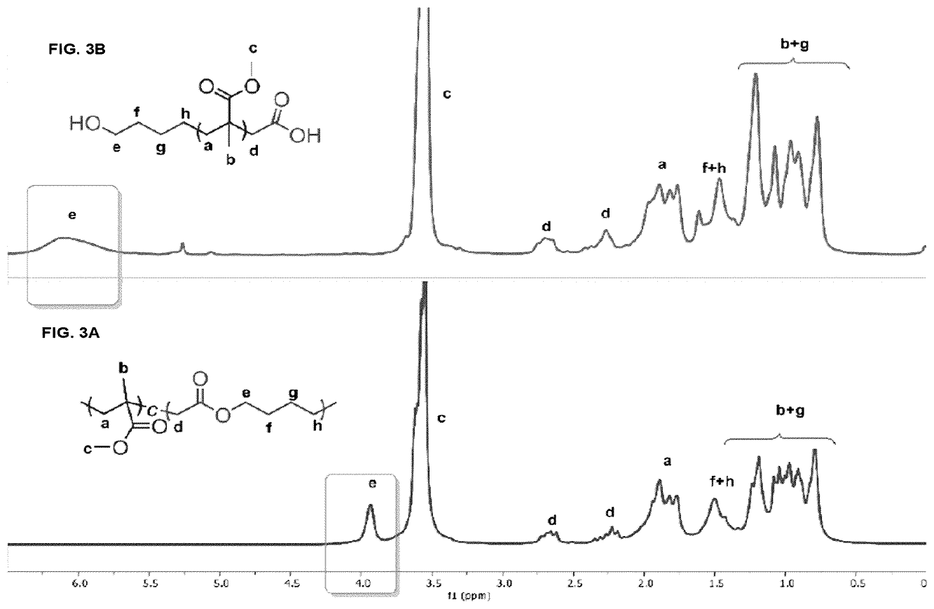

Referring now to FIG. 3A, ¹H-NMR (CDCl₃) analysis performed on microparticles of Sample 4a before hydrolytic degradation is shown. As can be seen from ¹H NMR of poly(MDO-co-MMA) (Sample 4a) in FIG. 3A, peak e at 3.95 ppm (—CH₂—C(O)O—CH₂*—) and peaks d between 2.7-2.2 ppm are methylene protons (—CH₂—C(O)O—CH₂*—) with regard to degradable units of polyester. The methylene protons adjacent to carbonyl (—CH₂*—C(O)O—) are often observed as a single peak in the homopolymerization of MDO, but are seen here as two (2) different peaks at 2.7 ppm and 2.2 ppm. The splitting is due to differences in configuration and the shift supports a copolymer with a random distribution of MDO units. The higher shifted peak at 2.7 ppm corresponds to a proton d where MDO is directly connected to acrylate and the lower shifted peak at 2.2 ppm corresponds to the same proton d where MDO monomers are connected within it. Peaks e and d are used to estimate the quantity of couplings, that is, the mol % of MDO monomer coupled to acrylate monomer in comparison to proton c (methyl ester of MMA) at 3.5 ppm.

Referring now to FIG. 3C, ¹³C NMR (CDCl₃) analysis performed on the microparticles of Sample 4a before hydrolytic degradation is shown. Peaks at 177.7 ppm and 170.4 ppm from ¹³C NMR correspond to carboxylate of PMMA and MDO, respectively, which are also used to estimate the quantity of monomer couplings.

Degradation of the poly(MDO-co-MMA) microparticles of Sample 4a will next be described. To a stirred solution of Sample 4a (100 mg) in THF (6 mL) was added a solution of KOH (200 mg) in Me0H (2 mL) at room temperature. The reaction mixture was stirred at room temperature for 48 hours. The reaction mixture was acidified to pH 4 to 5 with 6N HC1 at room temperature. Solvents were evaporated under reduced pressure and the obtained solids were dried under high vacuum for 2 hours to remove traces of solvents. CHCl₃ (10 ml) was added to the mixture of solids and stirred at room temperature for 2 hours. Resultant undissolved KCl salts were removed by syringe filtration and CHCl₃ was removed under reduced pressure to yield pale yellow viscous degraded polymer products (100 mg, crude). ¹H NMR (400 MHz, CDCl₃-d), δ (TMS, ppm): 6.06 (bs, 2 H, —HO—CH₂*—CH₂—CH₂—CH₂—, MDO), 3.60-3.54 (m, 3H, —C(O)O—CH₃*—, MMA), 2.75-2.64 (m, 2H, —CH₂*—C(O)OH, MDO), 2.42-2.23 (m, 2H, —CH₂*—C(O)OH, MDO), 2.04-1.76 (m, 2H (—CH₂*—, MMA), 1.61-1.37 (m, 2H (HO—CH₂—CH₂*—CH₂—CH₂—, MDO)+(m, 2H (HO—CH₂—CH₂—CH₂—CH₂*—, MDO), 1.25-0.77 (m, 2H, (HO—CH₂—CH₂—CH₂*—CH₂—, MDO)+(m, 3H, —CH₃, MMA); ¹³C NMR (400 MHz, CDCl₃-d), δ(TMS, ppm): 178.3-176.6 (—C*(O)O—CH₃, MMA)+(—C*(O)OH, MDO), 62.5 (HO—C*H₂—, MDO), 54.3, 52.1, 51.8, 45.0, 44.8, 44.4, 43.5, 43.2, 32.2, 29.6, 25.9, 23.6, 18.7, 17.9, 16.7, 16.2.

Poly(MMA-co-MDO) is structurally different than PMMA in a unique branching pattern in addition to the ester unit in the polymer backbone. Hence, the former has potential for more hydrophobic active absorption or encapsulation compared to PCL or other biopolymers.

Referring now to FIGS. 3B and 3D, ¹HNMR (CDCl₃) analysis performed on the microparticles of Sample 4a after hydrolytic degradation is shown in FIG. 3B and ¹³C NMR (CDCl₃) analysis performed on the microparticles of Sample 4a after hydrolytic degradation is shown in FIG. 3D. To demonstrate the degradability of Sample 4a, the microparticles were treated with an excess of potassium hydroxide (KOH) in a 1:3 mixture of methanol and tetrahydrofuran solvent combination at room temperature for 72 hours to afford short-chain methacrylate-based oligomers and the results are summarized in Table 3 below.

TABLE 3
Characterization of microparticles before and after hydrolytic degradation
(Sample 4a) and before hydrolytic degradation (Samples 4b and 4c)

| | | | | | | | | | Degradation | | | | |
|---|---|---|---|---|---|---|---|---|---|---|---|---|---|
| | | | | | Polymer Characterization | | | | Characterization (by | | | | Yield |
| | Conversion | | | | (by GPC) | | | | GPC) | | | | (%)/ |
| | of MMA/ | mol % | Polymer | | | | | PDI | | | | PDI | Solid |
| Sample | MDO | MDO- | composition^{b} | | | | | (M_{w}/ | | | | (M_{w}/ | content |
| ID | (%)^{a} | Polymer^{b} | MMA | MDO | Mₙ | M_{w} | Mₚ | Mₙ) | Mₙ | M_{w} | Mₚ | Mₙ) | (wt %) |
| 4a | 99/50 | 17 | 0.83 | 0.17 | 21,900 | 32,600 | 25,600 | 1.48 | 600 | 1000 | 800 | 1.75 | 55/10 |
| 4b^{c} | 99/50 | 17 | 0.83 | 0.17 | 26,600 | 53,400 | 38,300 | 2.00 | — | — | — | — | 55/10 |
| 4c^{c} | 99/60 | 30 | 0.70 | 0.30 | 7,200 | 16,000 | 11,600 | 2.22 | — | — | — | — | 65/10 |

^{a}Determined by 1H NMR analysis of crude polymeric emulsion;
^{b}Determined by 1H NMR analysis of a purified sample;
^{c}Hydrolytic degradation was not conducted as exemplified by Sample 4a

The microparticles were degraded by cleavage of ester bonds in the polymeric backbone, as revealed by a decrease in molar mass during hydrolysis.

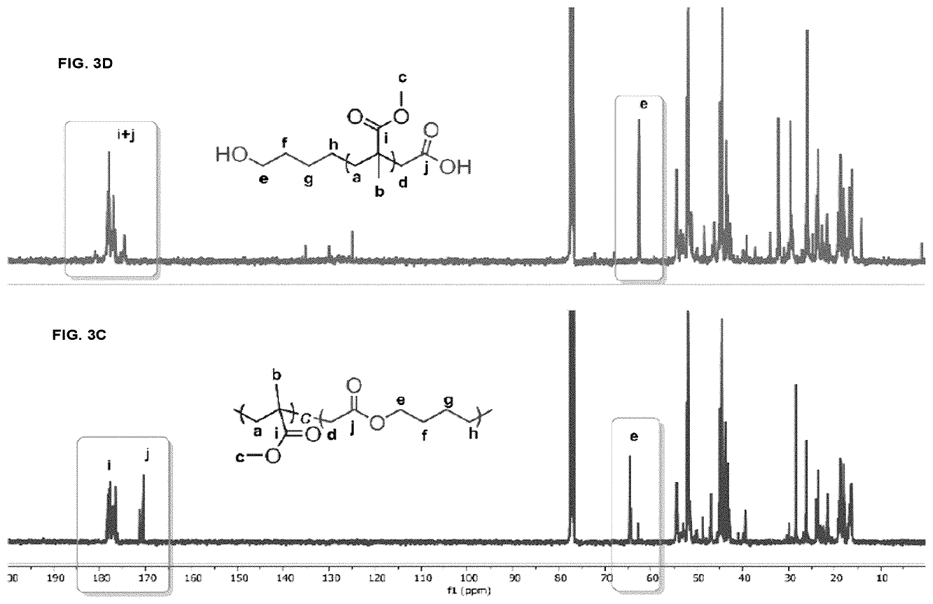

Referring now to FIG. 4A, gel permeation chromatography (GPC) analysis performed on the microparticles of Sample 4a before and after hydrolytic degradation is shown. As can be seen from Table 3, it was observed that copolymer with a higher molar mass (Mₙ) of 21,900 Da was degraded to oligomers with an average molecular weight smaller than 600 Da based on the degradable units in their polymer backbone. These values correlate nicely with the degree of main chain ester incorporation of 17 mol % calculated by ¹H-NMR. PDI values were recorded as 1.48 for purified particles and 1.75 for oligomers.

Referring now to FIG. 4B, GPC analysis performed on microparticles of Samples 4b and 4c before hydrolytic degradation is shown. As can be seen from Table 3, average molecular weight distribution (Mₙ) for microparticles of Samples 4b and 4c was observed to be 26,600 and 7,200 with 2.00 and 2.22 PDI, respectively. Lower Mₙ for Sample 4c was expected due to the higher mol % of MDO incorporation in the polymer backbone. A control experiment of non-degradable PMMA with known molecular weight distribution (Mₙ=28,100 Da) was also subjected to hydrolytic degradation to confirm its non-degradability nature. As expected, no change in molecular weight distribution was observed before (Mₙ=28,100 Da) and after (Mₙ=27,500 Da) hydrolytic degradation.

An observation was made in degradation reactions from the supporting data of ¹H, ¹³C NMR (see FIGS. 3B and 3D) and GPC analyses (see Table 3 and FIG. 4A) where shifting the peak e from 3.95 ppm to 6.2 ppm in ¹H NMR and a shift of carbonyl of MDO from 170.4 ppm to 177.0 ppm, and shifting the peak e corresponds to methylene carbon (—C(O)O—CH₂—) of MDO from 64.5 ppm to 62.5 ppm in ¹³C NMR were clear indications of polymeric backbone degradation. The GPC results also support the hydrolytic degradation where very significant degradation shifts were observed (see FIG. 4A).

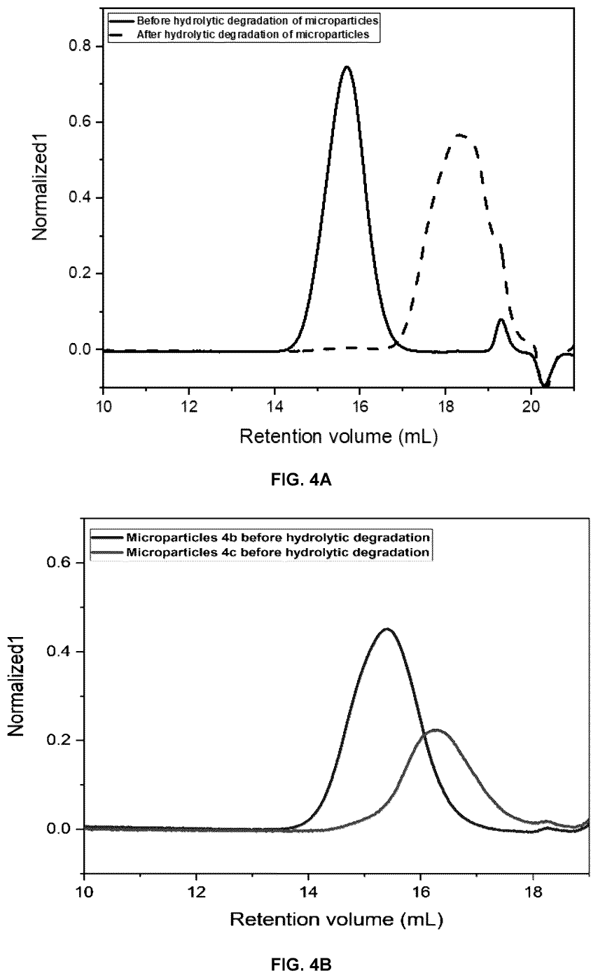

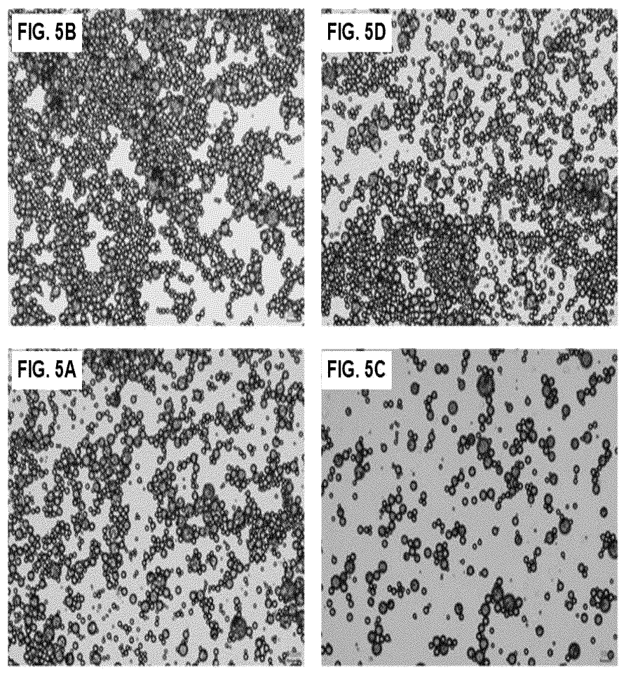

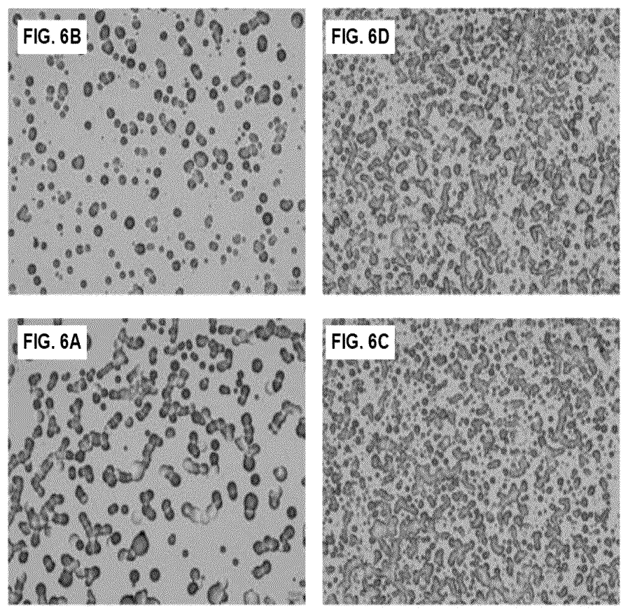

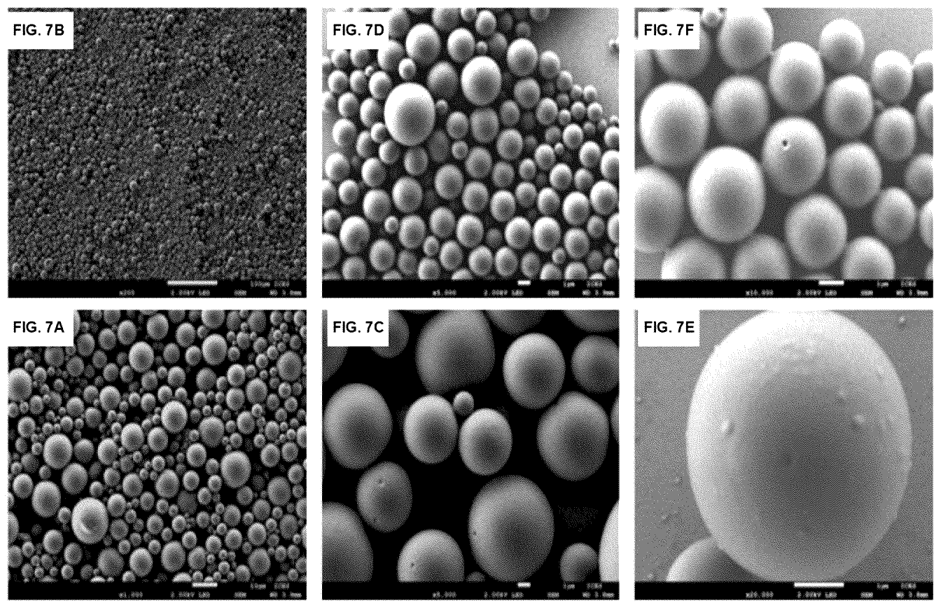

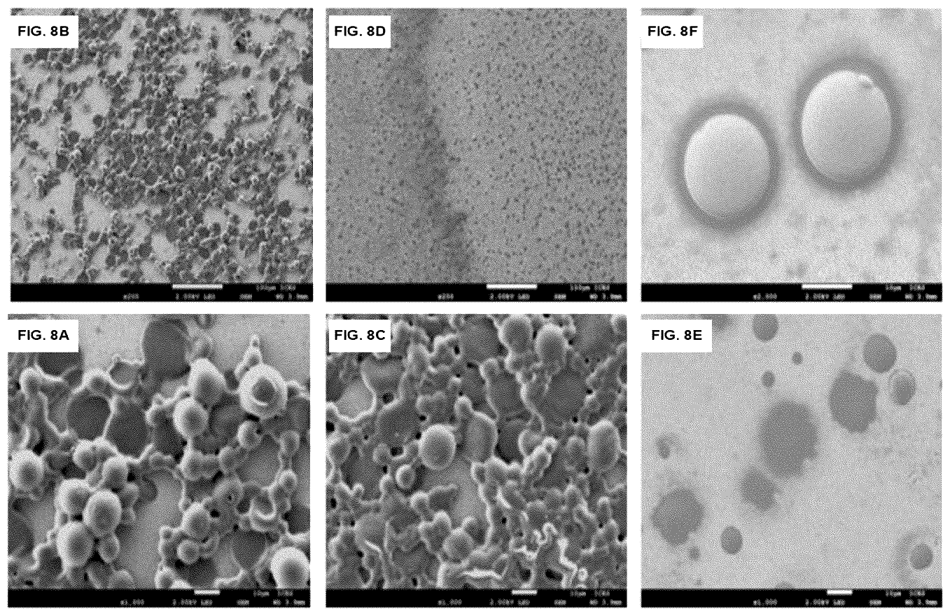

Referring now to FIGS. 5A through 9C, the polyacrylate microparticles of Samples 4a, 4b and 4c are next characterized by optical microscopy (see FIGS. 5A through 6D), Scanning Electron Microscopy (SEM) (see FIGS. 7A through 8F) and a particle size analyser (Mastersizer 3000 Hydro MV) (see FIGS. 9A through 9C and Table 2). Average particle size distribution for Samples 4a and 4b was shown to be 4.7 μm and 11.1 μm, respectively, by median particle diameter Dx (50) from each of three measurements. For Sample 4c, the particle size was displayed as 10.4 μm with a broad size distribution (PDI=0.4).

The broad size distribution may be because of aggregation or collapse of particles during analysis. All three of the dispersions were shown to be spherical in size and having smooth surfaces by SEM analysis and displayed no stability issues as of 3 weeks in dispersion state. Methyl acrylate microparticles (Sample 4b) and butyl acrylate microparticles (Sample 4c) were collapsed as evidenced by SEM analysis due to low Tg and/or higher amount of MDO incorporation (17-30%) in the polymer backbone.

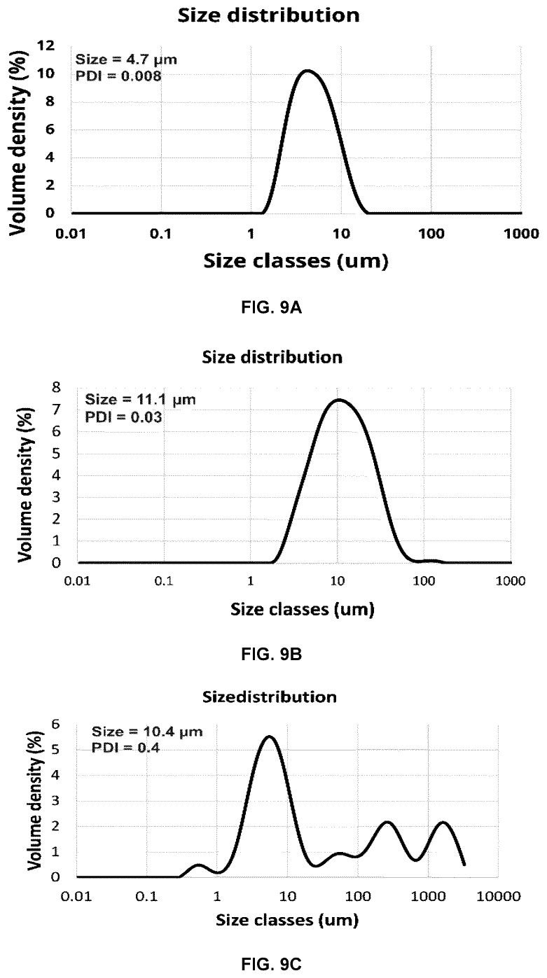

Referring now to FIGS. 10A through 10E, a comparison of polymerization methods (FIG. 10A by Solvent Switch Technique; FIG. 10B by emulsion; FIG. 10C by bulk; FIG. 10D by precipitation; and FIG. 10E by solution polymerization) by ¹H NMR (CDCl₃) analysis is shown. The comparison was made to check the quality of the poly(MDO-co-MMA) microparticles produced by the Solvent Switch Technique as compared to the same polymer or nanoparticles produced from other types of polymerizations like solution, bulk, precipitation and emulsion. It was observed that the quality or purity of the poly(MDO-co-MMA) is very high among all other polymerization methods by ¹H NMR comparison. From FIGS. 10A through 10E, it was observed that high purity of products was obtained over solution, precipitation and bulk polymerization.

The reason behind obtaining narrow molecular weight distributed polymer microparticles could be the long-chain polymers with periodical or uniform distribution of MDO throughout the polymer backbone is less soluble in the solvent system used leading to particle formation while keeping short MDO-rich or PMMA-rich chains in the solution as a dissolved state. This was also well corroborated by the narrow molecular weight distribution (PDI=1.48) of the particles by GPC analysis. The double advantage of the Solvent Switch Technique is the formation of microparticles and the elimination of short polymer chains from the system in a single step to obtain polymer chains with narrow molecular weight distribution. Elimination of short polymer chains from the system by the Solvent Switch Technique is advantageous for obtaining stable microparticles.

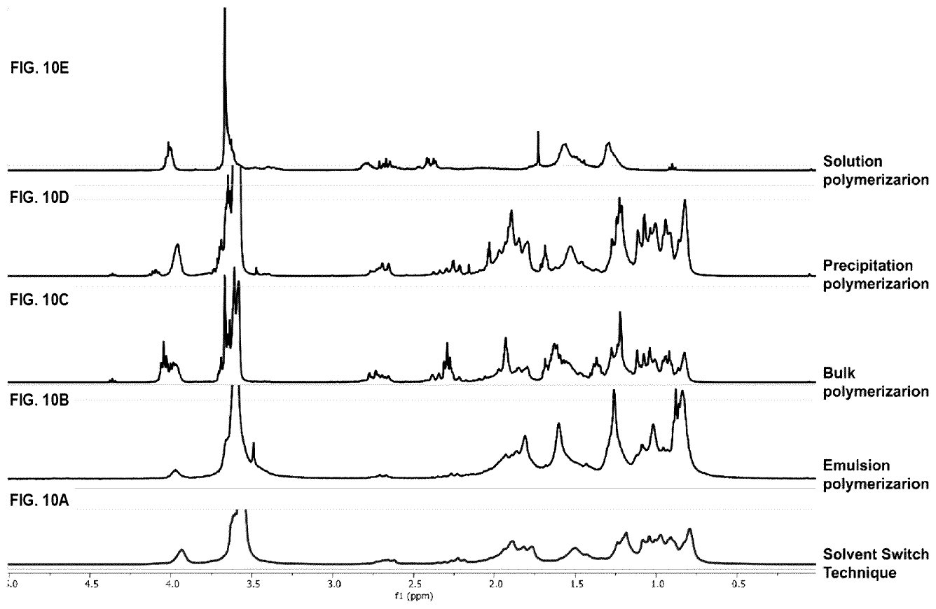

Referring now to FIG. 11, cytotoxicity of (A) RAW macrophage cells, (B) HaCat keratinocyte cells and (C) NIH/3T3 fibroblast cells in media containing different concentrations of polymer and oligomers is shown. In FIG. 11, dashed lines represent control cells in media without the polymers and oligomers and error bars are the standard deviation of n=3.

Evaluation of the toxicity of degradable PMMA (with 9 and 16 mol % of MDO incorporation) and corresponding oligomers on three different mammalian cell lines: macrophages (RAW 264.7), fibroblasts (NIH/3T3), and keratinocytes (HaCaT) are represented in FIG. 11. They were tested at varying concentrations (125 μg/mL, 250 μg/mL, 375 μg/mL, 500 μg/mL and 625 μg/mL) over time by suspending in culture media and subsequently adding to seeded cells. The control sample was the cell cultured in media without polymers added. WST-1 cytotoxicity assay was performed on the treated cells after 1, 3 and 5 days of incubation.

The result shows that degradable polymers (PMMA-9% and PMM-16%) did not induce cytotoxicity to three mammalian cell lines: macrophages (RAW 264.7), fibroblasts (NIH/3T3), and keratinocytes (HaCaT) at a concentration less than 500 μg/mL, which suggests that the degradable polymers (PMMA-9% and PMM-16%) may be safe to use. However, it was found that the cytotoxicity or cell death was induced when the concentration of the oligomers (dePMMA-9% and dePMMA-16%) exceeded 500 ug/mL. This result could be due to the smaller size of oligomers from PMMA-9% and PMM-16% entering the cells and inhibiting cell proliferation. These initial results may provide a way for better understanding of safe usage of polyacrylate degradable microparticles at lower concentrations in personal care applications.

In conclusion, degradable PMMA microparticles were successfully synthesized via radical ring-opening copolymerization of 2-methylene-1,3-dioxepane (MDO) with methyl methacrylate (MMA) in acetonitrile and subsequent emulsification in methanol via the Solvent Switch Technique. The technology also extended to other acrylate monomers such as methacrylate and n-butyl methacrylate and enables scalable production for a variety of biodegradable polyacrylates.

As proof of scalability, the approach was also performed on a 10 gram scale without any synthetic or technical issues. The obtained polymer particles in this system are well controlled for their particle size and molecular weight distribution and the degradable ester units in the main-chain are optimal to provide the oligomers with small molecular weight that can help to enhance environmental biodegradability of the polymer. In addition, cytotoxicity of degradable PMMA and its oligomers was also performed where degradable PMMA polymers and corresponding oligomers did not induce toxicity at lower concentrations. These formulations may be preferred in personal and biomedical applications in which degradability and/or biodegradability and safe usage are essential.

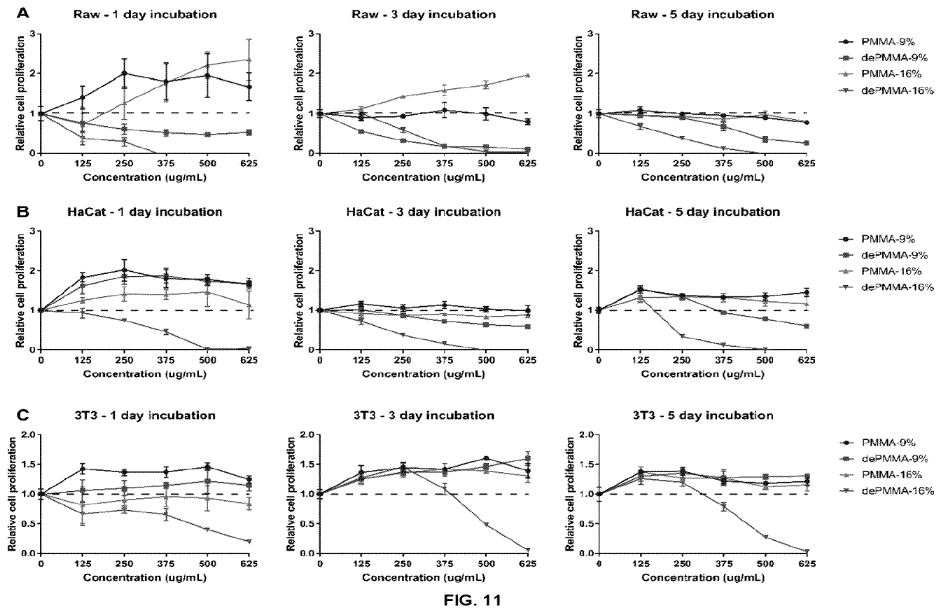

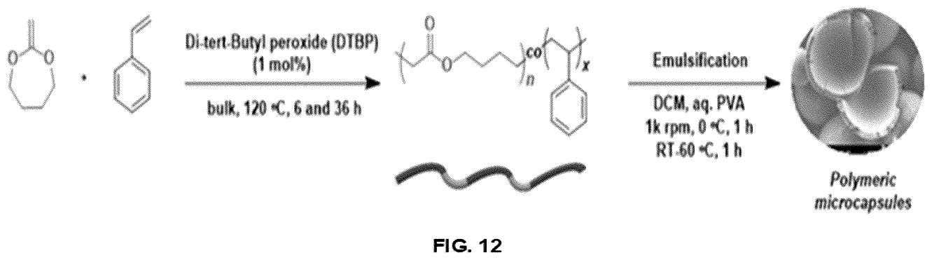

Referring now to FIGS. 12 and 13, a scheme for free radical ring-opening polymerization of (rROP) of MDO with styrene followed by Solvent Switch Technique to afford main-chain degradable polystyrene microcapsules is shown. Monomodal (narrow dispersed) chemically degradable polystyrene (PS) core-shell microcapsules with two variable shell thicknesses (thick and thin) were synthesized by the solvent switch technique shown in FIGS. 12 and 13.

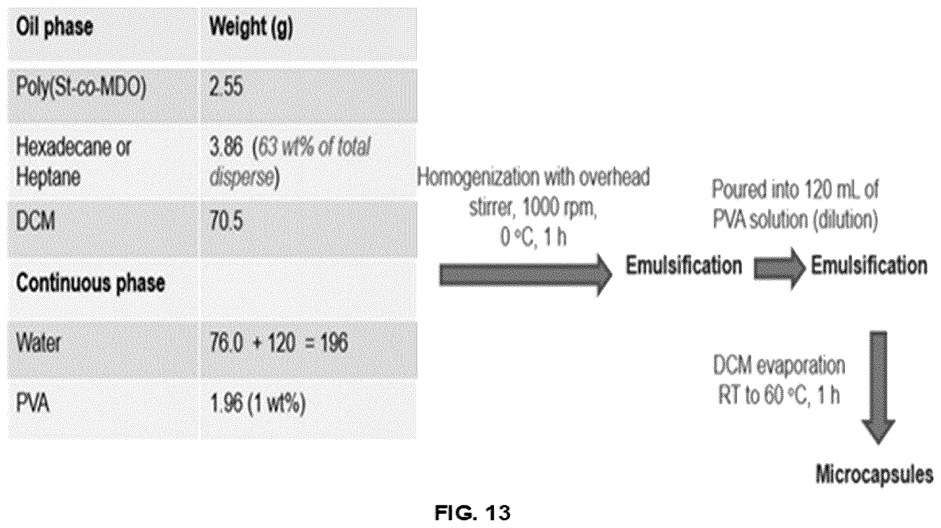

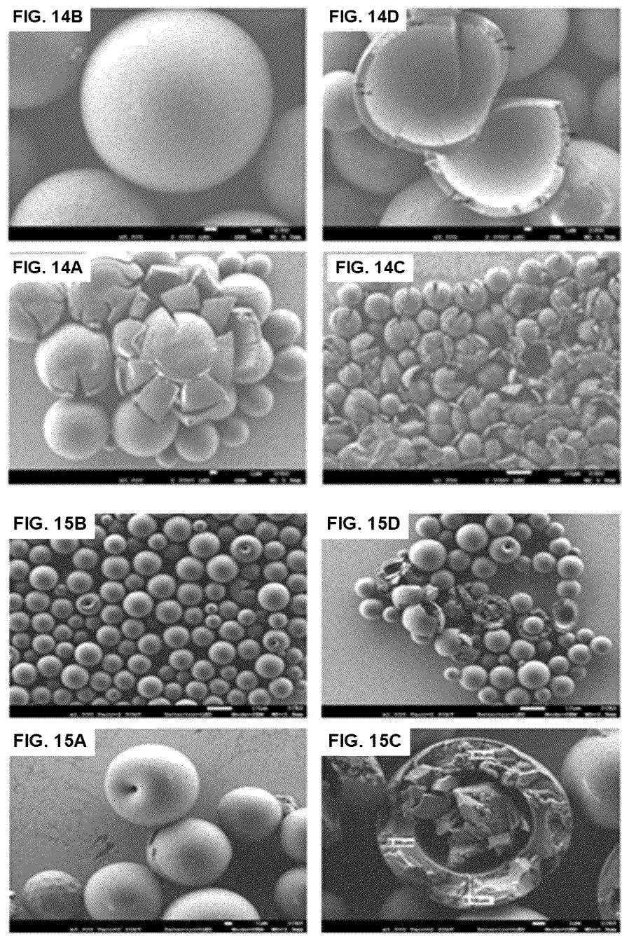

Referring now to FIGS. 14A through 15D, Scanning Electron Microscopy (SEM) images for degradable polystyrene microcapsules with hexadecane as core material (FIGS. 14A through 14D) and with heptane as core material (FIGS. 15A through 15D) are shown. Variations in shell thickness were observed when high (hexadecane) and low (heptane) boiling point solvents were used. As can be seen from FIGS. 14A through 15D, thin and thick shells were observed for hexadecane and heptane as core material, respectively. Average shell-thickness for hexadecane-encapsulated and heptane-encapsulated microcapsules was measured to be 1.35 μm (see FIG. 14D) and 3.01 μm (FIG. 15C), respectively.

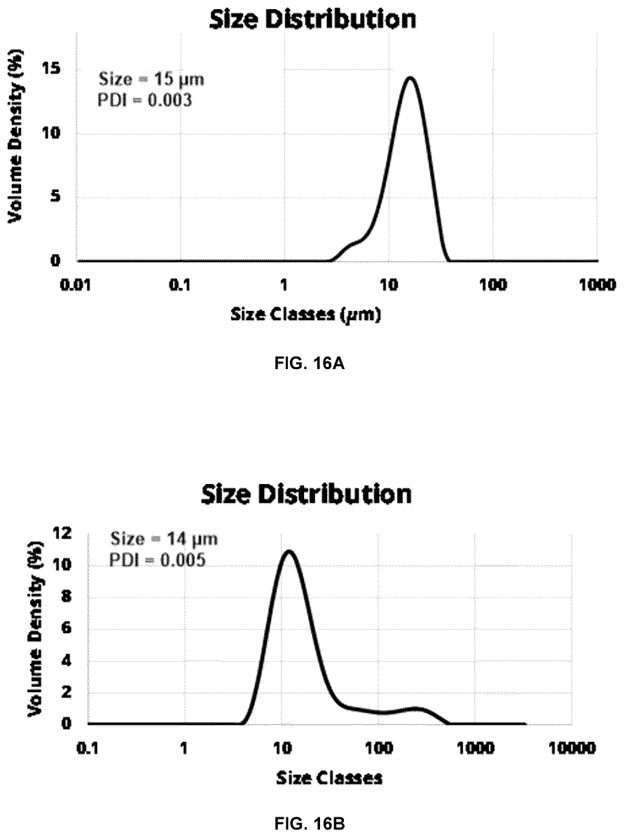

Referring now to FIGS. 16A and 16B, graphs showing particle size distribution of the degradable polystyrene microcapsules with hexadecane and heptane as core material are shown. The average capsule size distribution by Malvern Mastersizer 3000 was found as 15 μm and 14 μm with narrow PDI (<0.1) for thin and thick-shell PS capsules, respectively.

As is evident from the foregoing discussion, the present disclosure provides a polymer particle production method that produces polymer particles that are well controlled in terms of particle size and molecular weight distribution with a high amount of incorporation of degradable ester units in the polymer backbone through use of a unique solvent combination, for example, acetonitrile and methanol. Advantageously, the polymer particle production method of the present disclosure may be used to produce degradable polyacrylate microparticles under conventional polymerization and emulsification conditions, requiring no special equipment or high shear homogenizer.

The polymer particle production method of the present disclosure may be used to synthesize monomodal micron-sized particles with narrow size molecular weight distribution and with optimal level of ester linkages in the polymer backbone to result in smaller size oligomers under conventional conditions. By combining polymerization and the Solvent Switch Technique, the polymer particle production method of the present disclosure provides hydrolytically degradable and biodegradable polymer particles.

The polymer particle production method of the present disclosure may be used to synthesize poly(acrylate-co-MDO) copolymers in acetonitrile, followed by subsequent formation of microparticles in methanol by the Solvent Switch Technique. By radical ring-opening polymerization of MDO with vinyl acrylates followed by Solvent Switch Technique, biodegradable polyacrylate microparticles may be produced by polymer particle production method of the present disclosure.

Subsequent hydrolytic degradation of the microparticles affords oligomeric degradation products that help to calculate mol % of degradable units in the main-chain polymer backbone. In addition, the degradable (aliphatic ester) units in the polymer backbone are optimal to result in oligomers with small molecular weight that can help to enhance environmental biodegradability of the polymer. A scalable approach to form microparticles is provided since industrial solvents are used for the solvent switching.

The biodegradable micron-sized polymer particles prepared from the polymer particle production method of the present disclosure may be used in a variety of personal care applications (for example, film formers, oil-absorbents or oil-controlling agents, agents to provide sensory benefits, etc.) as a replacement for currently used non-degradable particles. These formulations are highly preferred in various industrial applications where degradability and/or biodegradability are required at the end of the lifespan of the polymer produced. In addition, the degradable particles may be employed in the biomedical field as both polymer segments are known to be biocompatible and non-toxic.

While preferred embodiments have been described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to.”

What is claimed is:

1. A polymer particle production method, comprising:
providing one or more vinyl monomers;
performing free radical ring-opening polymerization (rROP) of cyclic ketene acetal (CKA) with the one or more vinyl monomers in a first organic solvent with a radical source to obtain a rROP reaction mixture; and
emulsifying the rROP reaction mixture in a second organic solvent to produce a plurality of polymer particles.

2. The polymer particle production method of claim 1, wherein the one or more vinyl monomers are one or more selected from a group consisting of acrylate monomer, vinyl acrylate monomer, methacrylate (MA) monomer, methyl methacrylate (MMA) monomer, ethylene glycol dimethylacrylate (EGDMA) monomer, 2-hydroxyethyl acrylate (HEA) monomer, n-butyl methacrylate (n-BuMA) monomer and styrene monomer.

3. The polymer particle production method of claim 1, wherein the cyclic ketene acetal (CKA) is 2-methylene-1,3-dioxepane (MDO).

4. The polymer particle production method of claim 1, wherein a monomer ratio of the one or more vinyl monomers is to the cyclic ketene acetal (CKA) is from between about to about 80:20.

5. The polymer particle production method of claim 1, wherein the first organic solvent is selected from a group consisting of acetonitrile (CH₃CN), ethanol (EtOH), tert-butanol (t-BuOH), isopropyl alcohol (IPA), dioxane, acetone, dimethylsulfoxide (DMSO) and tetrahydrofuran (THF).

6. The polymer particle production method of claim 1, wherein the radical source is selected from a group consisting of azobisisobutyronitrile (AIBN) and di-tert-butyl peroxide (DTBP).

7. The polymer particle production method of claim 1, wherein performing free radical ring-opening polymerization (rROP) of the cyclic ketene acetal (CKA) with the one or more vinyl monomers in the first organic solvent with the radical source to obtain the rROP reaction mixture comprises:
adding a non-ionic stabilizer to a mixture of the cyclic ketene acetal (CKA), the one or more vinyl monomers and the radical source before addition of the first organic solvent.

8. The polymer particle production method of claim 7, wherein the non-ionic stabilizer is selected from a group consisting of polyvinylpyrrolidone (PVP) or poly(ethylene glycol)-block-poly(ϵ-caprolactone) (PEG-b-PCL).

9. The polymer particle production method of claim 7, wherein the rROP reaction mixture has a stabilizer loading of between about 0.33 percentage by mass (wt %) and about wt % of a total reaction mixture.

10. The polymer particle production method of claim 1, wherein emulsifying the rROP reaction mixture in the second organic solvent to produce the plurality of polymer particles comprises:
adding the rROP reaction mixture dropwise into the second organic solvent.

11. The polymer particle production method of claim 1, wherein the second organic solvent is one or more selected from a group consisting of methanol, ethanol, propanol, hexadecane, heptane, and dichloromethane (DCM).
